(19) United States
(12) Patent Application Publication
(10) Pub. No.: US 2006/0225780 A1
(43) Pub. Date: Oct. 12, 2006

(54) Rooftop photovoltaic module

(75) Inventors: Bertrand Leroy Johnson III, Memphis, TN (US); Kenneth Richard Boswell, Bartlett, TN (US); Akimasa Umemoto, Albuquerque, NM (US)

Correspondence Address: Larry W. McKenzie;Walker, McKenzie & Walker, P.C., Suite 434, 6363 Poplar Avenue, Memphis, TN, 38119-4896, US

(73) Assignee: Sharp Manufacturing Company of America, A Division of Sharp Electronics Corporation, Memphis, TN (US)

(21) Appl. No.: 11/400,022

(22) Filed: Apr. 7, 2006

Related U.S. Application Data
(60) Provisional application No. 60/669,659, filed on Apr. 8, 2005.

(51) Int. Cl. H02N 6/00

(52) U.S. Cl. 136/244

(57) ABSTRACT

A photovoltaic module for installation with roof tiles on a sloping roof. The photovoltaic module includes a photovoltaic panel; a frame surrounding the panel; and attachment structure for allowing the panel and the frame to be attached to a sloping roof in an interlocking and overlapping fashion with roof tiles while allowing adjustment of the location of the panel and the frame along the slope of the sloping roof.

### CROSS REFERENCE TO RELATED APPLICATIONS

This application is a non-provisional application claiming priority of pending U.S. provisional application 60/669,659, filed Apr. 8, 2005, entitled “PHOTOVOLTAIC SYSTEM OF INTERLOCKING ROOFTOP MODULES,” fully incorporated herein by reference.

### BACKGROUND OF THE INVENTION

1. Field of the Invention

This invention relates generally to the field of photovoltaic generation of electricity and more specifically to a photovoltaic module and a system of interlocking rooftop photovoltaic modules.

2. Background Art

Solar photovoltaic (PV) systems convert energy from the sun's radiation directly into electricity for a multitude of end uses. One common application of PV systems is installation on the roofs of residences, where electricity generated as direct current is inverted to alternating current and used to displace utility grid-generated electricity for house electrical loads, such as heating and light. In houses that use concrete tile roofs or similar construction, specialized PV modules substitute directly for concrete tiles while maintaining a physical profile similar to the tiles. These “roof tile” modules thus present an aesthetic that is considered more appealing than conventional PV installations that use conspicuous extruded metal (or similar) mounting systems. Roof tile modules also have the potential for lower installation costs than traditional PV installations, since the mounting system is integrated with the module.

Currently used roof tile PV module technology uses fundamentally similar arrangements of components to the present invention, which includes photovoltaic cells protected by a front side superstrate (e.g., glass) and a back side substrate (e.g., a polymer film backing), and framed with an extruded or bent metal frame for support. The current technology is generally designed to integrate with a limited range of sizes of concrete tiles. These modules screw or nail directly into the house roof, and require additional installation pieces for mounting.

The current technology uses screws in the side of a module frame for electrical grounding, with significant associated installation labor. Current modules are not generally designed to adapt to multiple sizes of concrete tiles. These modules are many times designed to screw or nail directly into the house roof, which increases the likelihood of water leakage through the roofing system. This lack of integrity in the PV array system also results in a requirement for roof tile PV modules that are deeper (ridge-to-soffit) than absolutely necessary in order to form an overlap between modules in an attempt to remedy the deficiency in their water resistance capabilities, with accompanying higher material costs. The additional installation pieces required for mounting also increases the labor time required for installation.

Nothing in the known prior art, either singly or in combination, disclose or suggest the present invention.

### BRIEF SUMMARY OF THE INVENTION

One object of the invention is to provide a building-integrated photovoltaic module and system with electrical grounding that is easier to install than previous systems.

Another object of the invention is to provide a photovoltaic module and system with electrical grounding that is less expensive than previous modules and systems.

A further object of the invention is to provide a building-integrated photovoltaic module and system that does not require extra roof penetrations, thereby reducing water leak potential.

Another object of the invention is to provide an interlocking photovoltaic module and system that uses less frame material while maintaining or enhancing water resistance.

Yet another object of the invention is to provides a concrete roof tile-compatible photovoltaic module and system adaptable to a variety of roof tile sizes.

Still yet another object of the invention is to provide a simple, low cost method of restraining the front edge of a row of photovoltaic modules integrated into a concrete tile roof.

Another object of the invention is to provide a simple, low cost method of restraining electrical cables in a building-integrated photovoltaic module and system.

Another object of the invention is to provide means for reducing the build-up of hot air underneath a building-integrated photovoltaic module and system.

Other objects and advantages of the present invention will become apparent from the following descriptions, taken in connection with the accompanying drawings, wherein, by way of illustration and example, preferred embodiments of the present invention is disclosed.

### BRIEF DESCRIPTION OF THE SEVERAL VIEWS OF THE DRAWINGS

FIG. 1 is a somewhat diagrammatic perspective view showing portions of a roof with a plurality of concrete roof tiles and a plurality of the photovoltaic modules of the present invention installed thereon.

FIG. 2 is a somewhat diagrammatic perspective view of the photovoltaic module of the present invention with portions thereof in moved, exploded positions for clarity.

FIG. 3 is a sectional view substantially as taken on line 3-3 of FIG. 1 on an enlarged scale and with portions thereof broken away or shown diagrammatically for clarity.

FIG. 4 is a sectional view substantially as taken on line 4-4 of FIG. 1 on an enlarged scale.

FIG. 5 is a sectional view substantially as taken on line 5-5 of FIG. 1 on an enlarged scale.

FIG. 6 is a sectional view substantially as taken on line 6-6 of FIG. 1 on an enlarged scale.

FIG. 7 is a sectional view substantially as taken on line 7-7 of FIG. 2 on an enlarged scale and with portions thereof shown in moved positions for clarity.

FIG. 8 is a sectional view substantially as taken on line 8-8 of FIG. 2 on an enlarged scale and with portions thereof shown in moved positions for clarity.

FIG. 9 is an exploded perspective view of a portion of a frame member of the photovoltaic module of the present invention, showing a ground lug and an electrical cable restraint in combination therewith.

FIG. 10 is a perspective view of a portion of a frame member of the photovoltaic module of the present invention, showing a ground lug made integral therewith.

FIG. 11 is a perspective view of a portion of a frame member of the photovoltaic module of the present invention, showing a pair of ground lugs made integral therewith.

### DETAILED DESCRIPTION OF THE INVENTION

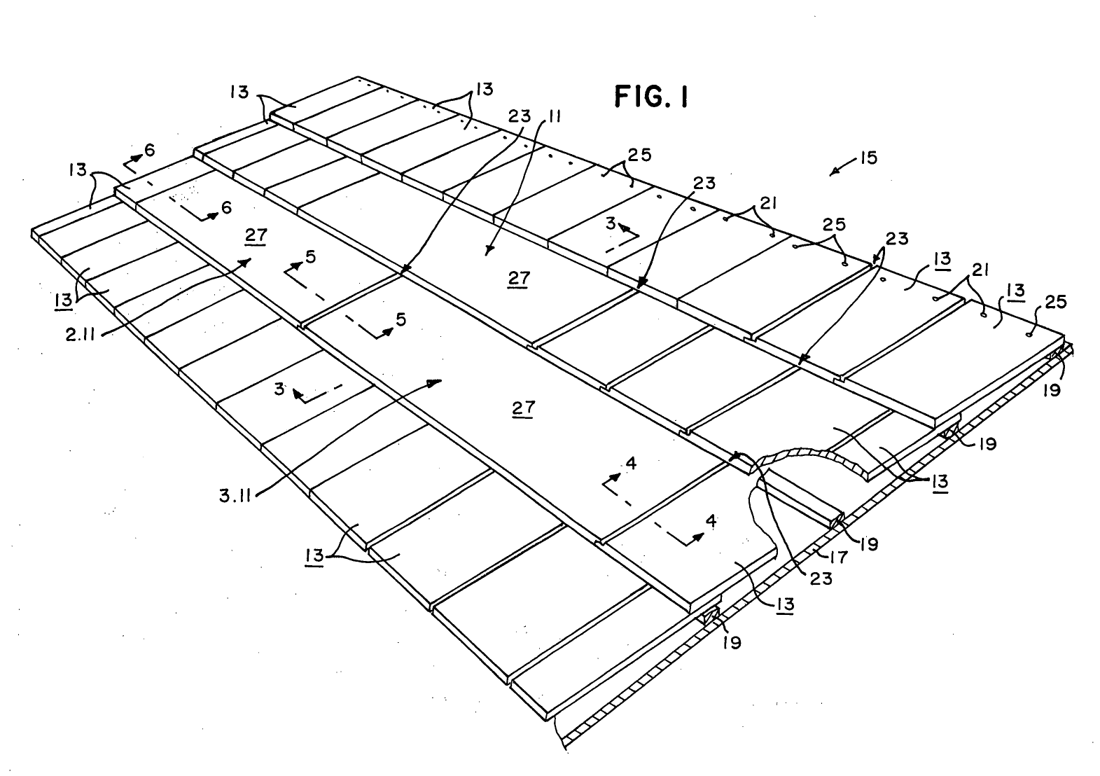

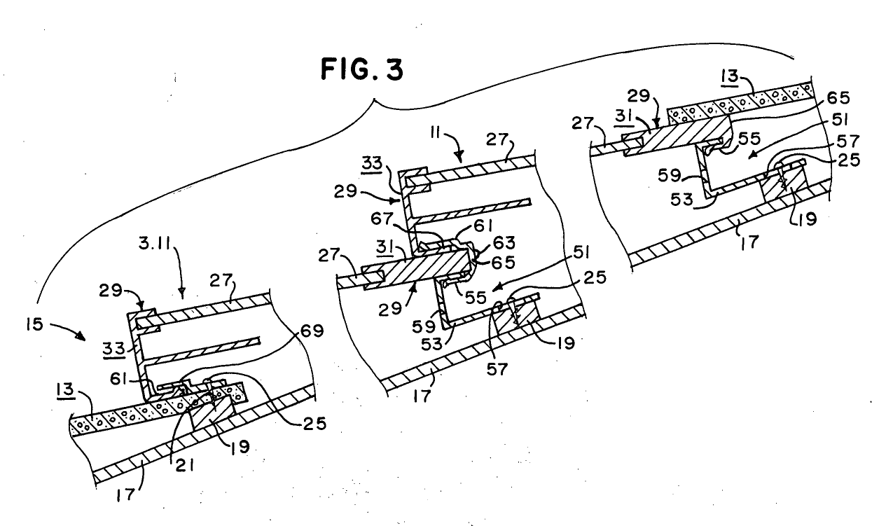

A preferred embodiment of the photovoltaic module of the present invention is shown in the drawings and identified by the numeral 11. The photovoltaic module 11 is designed for integrated and interconnected use with a plurality of like photovoltaic modules (e.g., a second photovoltaic module 2.11, and a third photovoltaic module 3.11 as shown in FIG. 1), and a plurality of roof tiles (e.g., concrete roof tiles 13 as shown in FIG. 1) on a roof 15. The roof 15 includes a roof deck 17 and a plurality of battens 19 which extend generally horizontally across the roof deck 17 for allowing the roof tiles 13 to be attached to and installed on the roof deck 17 in any typical manner as will now be apparent to those skilled in the art. For example, each roof tile 13 may have a pair of spaced apart apertures 21 adjacent the top edge thereof through which screws, nails or the like (not shown) can be used to secure the roof tile 13 to a batten 19, and thus to the roof 15. FIG. 1 shows the general arrangement of a system of photovoltaic modules 11, 2.11, 3.11, etc., designed for, and integrated into, a roof 15 of substantially flat concrete tiles 13 or the like. Important and standard features of such a system are that the photovoltaic modules 11, 2.11, 3.11, etc., retain the same basic profile as the remainder of the roof 15, that the photovoltaic modules 11, 2.11, 3.11, etc., integrate with the tiles 13 in an overlapping fashion so as to form water channels 23 along the side edges of the tiles 13 and photovoltaic modules 11, 2.11, 3.11, etc., to prevent leakage to the roof 15, and that the rows of tiles 15 and photovoltaic modules 11, 2.11, 3.11, etc., alike are staggered. With respect to the present invention, the back (upper) edge of the photovoltaic module 11 is preferably fixed to the roof 15 in the same manner as a typical concrete roof tile 13, i.e., by way of a nail or screw 25 that extends into a batten 19 but not through the roof deck 17 (see FIG. 3) so as not to compromise the waterproof integrity of the roof 15. The front (lower) edge of the photovoltaic module 11 rests solely on a lower module (e.g., the module 2.11 or 3.11 as shown in FIGS. 1 and 3) or lower tile 13 (see FIG. 3) underneath. This allows the photovoltaic module 11 to be fixed to the roof 15 without penetrations additional to those required for the fixing of concrete tiles 13 to battens 19.

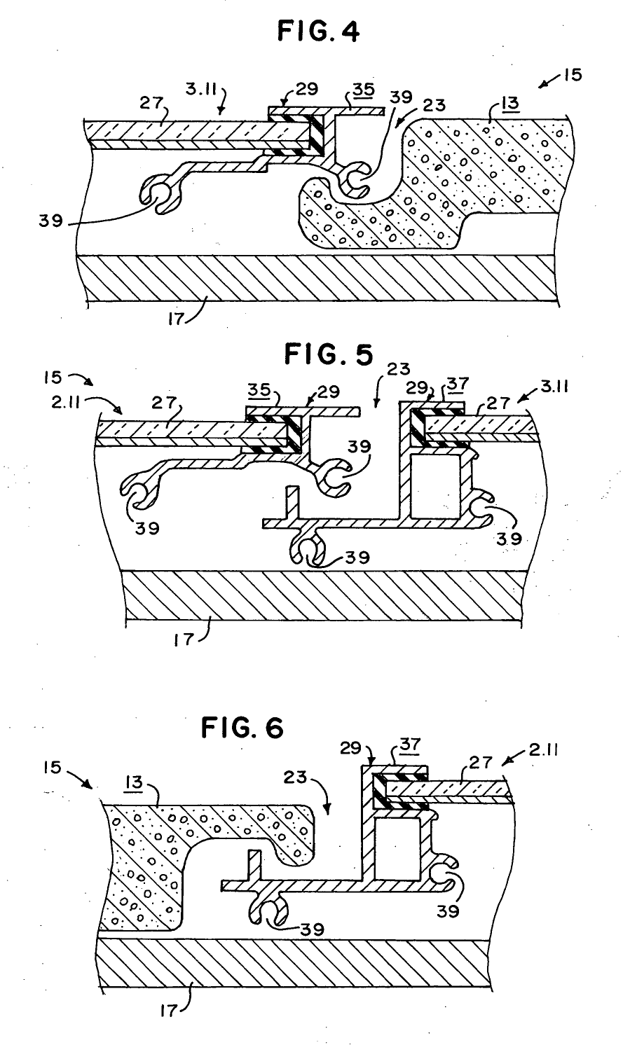

The module 11 preferably includes, in general, a photovoltaic panel 27, and a frame 29 surrounding the panel 27. The panel 27 may be of any standard construction well know to those skilled in the art, typically having a transparent glass front side, a weather-resistant back side, and a plurality of encapsulated solar cells in between and electrically coupled to an electrical terminal box or the like. The frame 29 preferably includes a back or upper frame member 31 for extending across the back or upper edge of the panel 27, a front or lower frame member 33 for extending across the front or lower edge of the panel 27, a first or right side frame member 35 for extending across the first or right side edge of the panel 27, and a second or left side frame member 37 for extending across the second or left side edge of the panel 27. The various frame members 31, 33, 35, 37 are preferably extruded out of aluminum or the like with the specific cross sectional shapes as shown in FIGS. 4-8.

The side frame members 35, 37 preferably have screw beads 39 formed therein for allowing the lower frame member 33 to be secured thereto via screws (not shown) about the panel 27 as will now be apparent to those skilled in the art.

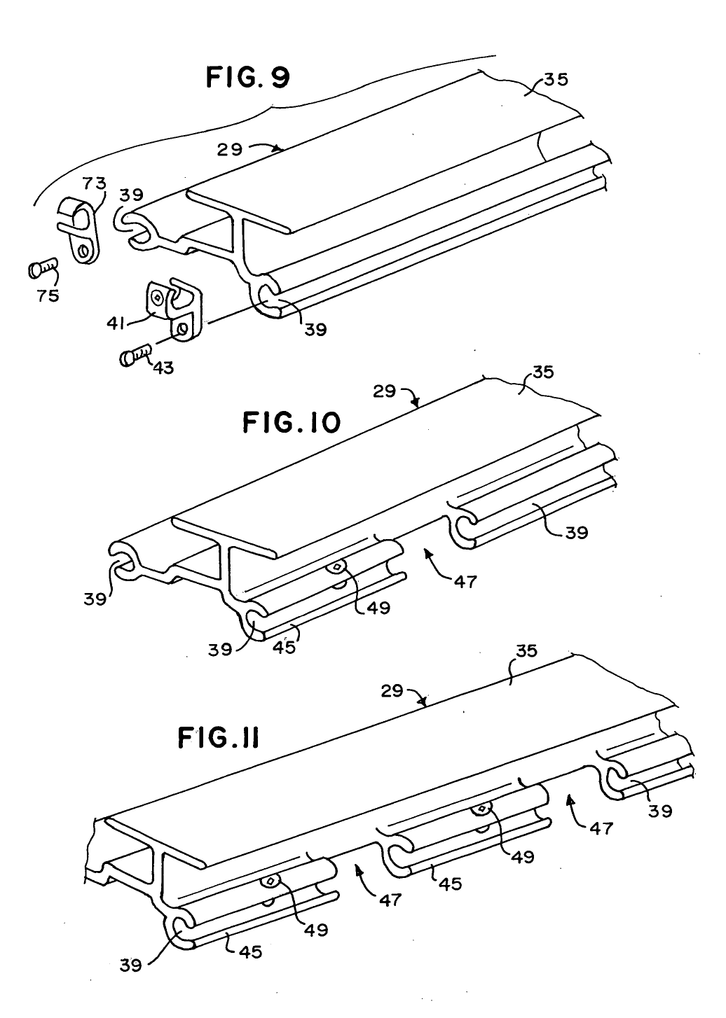

Electrical codes require that the photovoltaic modules 11, 2.11, 3.11, etc., be electrically grounded at a single electrical point. As shown in FIG. 9, a typical ground lug 41 may be attached by way of a screw 43 to an unused portion of a screw bead 39 or other similar extrusion shape in the right or left side frame member 35, 37, etc. By thus providing the ability to installing a standard lay-in type ground lug 41 on an easily accessible place on the module 11, 2.11, 3.11, etc., once the ground lug 41 is attached to the screw bead 39, the grounding can be done with all the modules 11, 2.11, 3.11, etc., in place and in a row rather than having one installer hold up one module 11, 2.11, 3.11, etc. so another installer can screw a ground wire into a lug or screw located on the bottom or other less accessible place on the modules 11, 2.11, 3.11, etc.

FIG. 10 shows an alternate ground lug 45 made integral with one of the screw beads 39 of the right side frame member 35, etc., by simply milling or otherwise forming a slot 47 in the screw bead 39 and adding a set screw 49 to the bead 39 so that a grounding cable (not shown) can be passed through the ground lug 45, electrically connected to the frame member 35 by use of the set screw 49, and allowed to exit the ground lug 45 via the slot 47. In an alternate embodiment, such as when more than one grounding conductor is terminated at a module 11, 2.11, or 3.11, etc., it may also be advantageous to provide multiple side-by-side, integral ground lugs 45 in a single screw bead 39 as illustrated in FIG. 11. The ground wires (not shown) can be, if desired, installed in the integral ground lugs 45 prior to field assembly of the photovoltaic modules 11, 2.11, 2.11, etc., to further simplify the installation process.

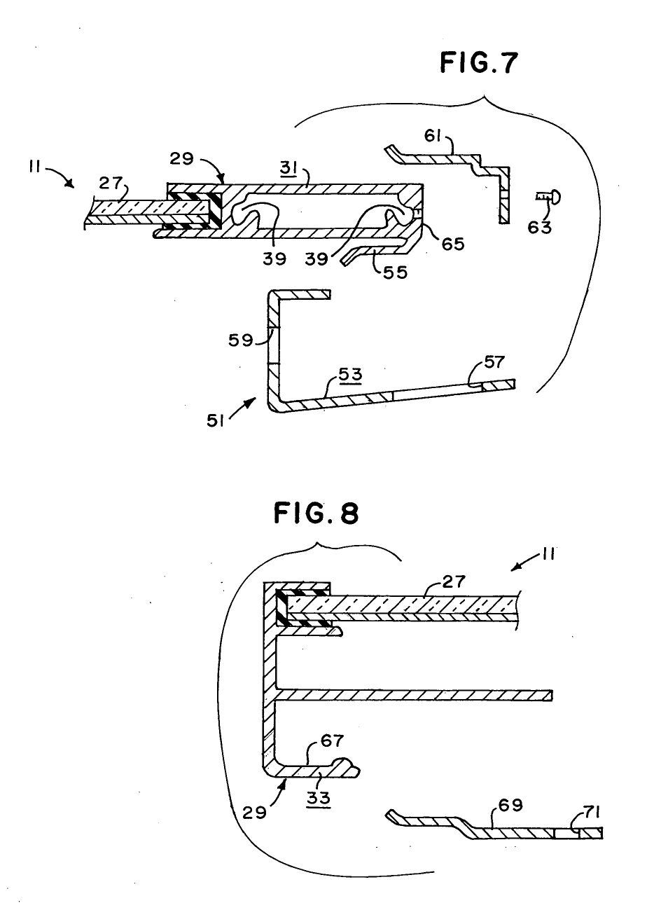

Each module 11, 2.11, 3.11, etc., includes an attachment means 51 for attaching the photovoltaic modules 11, 2.11, 3.11, etc., to a sloping roof 15 in an interlocking and overlapping fashion with roof tiles 13 and one another while allowing adjustment of the location of the photovoltaic modules 11, 2.11, 3.11, etc., along the slope of the sloping roof 15. The attachment means 51 allows the photovoltaic modules 11, 2.11, 3.11, etc., to be attached to the batten 19, preferably without penetrating other parts of the roof 15. The attachment means 51 preferably includes an upper attachment bracket 53 for being attached to the roof 15 and to the upper frame member 31 of the frame 29 (see, in general, FIG. 3) to thereby attach the photovoltaic modules 11, 2.11, 3.11, etc., to the roof 15. The upper attachment bracket 53 is preferably removably attached to the upper frame member 31 via a clip 55 on the bottom side of the upper frame member 31 (see FIGS. 3 and 7) and is preferably attached to the roof 15 via the screws 25 into the battens 19 (see FIG. 3). Making the bracket 53 separate and removable from the upper frame member 31 allows easy removal of damaged modules 11, 2.11, 3.11, etc., after solar system installation by disengaging the broken module 11, 2.11, 3.11, etc., from the mounted upper attachment bracket 53. The upper attachment bracket 53 preferably has a plurality of vertical slots 57 therethrough for the screws 25 to allow adjustment of the position or location of the photovoltaic modules 11, 2.11, 3.11, etc., along the slope of the roof 15, i.e., in the ridge-eave direction, in order to align the modules 11, 2.11, 3.11, etc., with roof tiles 13 of a variety of sizes with respect to the length of the roof tiles 13. The buildup of hot air underneath photovoltaic modules has the tendency to degrade module electrical performance. The upper attachment bracket 53 preferably has a plurality of vent holes 59 therein for reducing heat build-up beneath the modules 11, 2.11, 3.11, etc. Hot air will rise through the vent holes 59 toward the roof ridge and reduce the temperature underneath the modules 11, 2.11, 3.11, etc., and decrease the possibility of module electrical performance degradation, etc.

In industry practice, the dimension and shape of the side edges of standard concrete roof tiles 13 used to form water channels 23 vary. FIG. 4 shows the details of the overlap of the right side frame member 35 of the module 3.11 with left side channel of a right side roof tile 13. FIG. 5 shows the details of the overlap of the right side frame member 35 of the module 2.11 with the left side frame member 37 of the module 3.11. FIG. 6 shows the details of the overlap of the left side frame member 37 of the module 2.11 with a left roof tile 13. These various overlaps form water resistant joints.

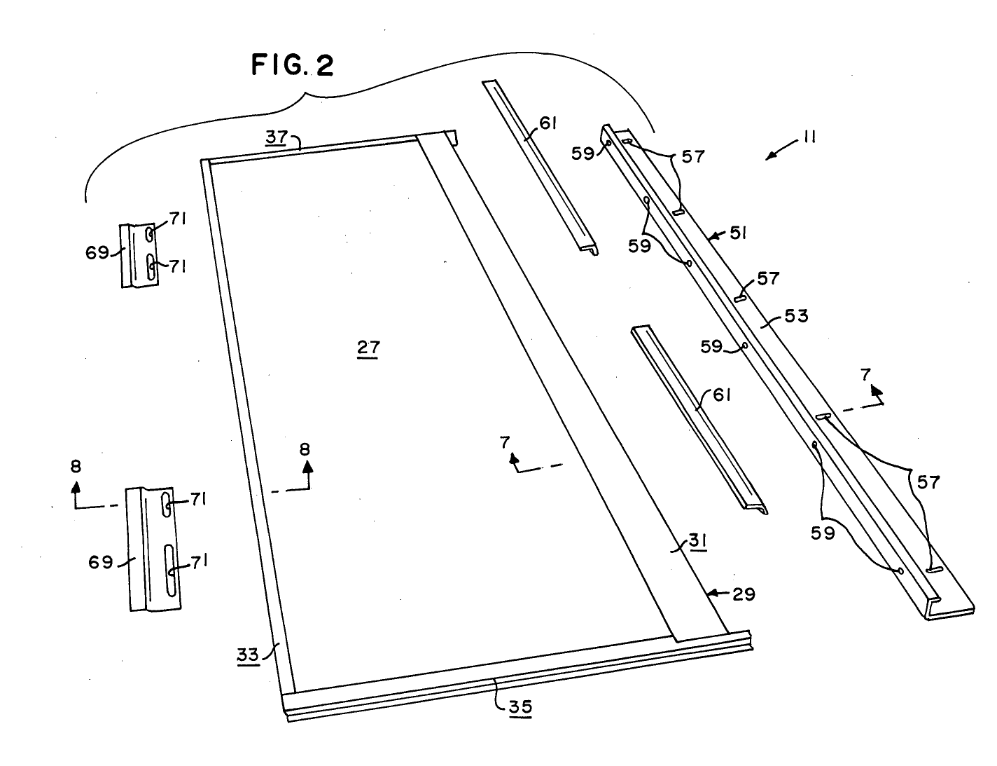

A top mounting clip 61 is shown in FIGS. 2, 3 and 7 for use in securing the top edge of a lower module (e.g., the module 3.11 in FIG. 2) and the lower edge of an upper module (e.g., the module 11 in FIG. 2) together. The top mounting clip 61 removably mounts to the upper frame member 31 via screws 63 or the like (see FIGS. 3 and 7). Preferably, the upper frame member 31 has a normally generally vertical upper face 65 and the clip 61 is preferably attached to the face 65 by way of the screw 63 to reduce the potential for water penetration into the frame 29 as would be the case if the screw 63 were to pass through a more horizontally directed area of the upper frame member 31. A rearwardly extending bottom lip 67 of the lower frame member 33 of an upper module (i.e., the module 11 in FIG. 3) can slip under the retaining clip 61 of the module below it (i.e., the module 3.11 in FIG. 3) during installation to secure the top edge of the lower module (e.g., the module 3.11 in FIG. 3) and the lower edge of the upper module (e.g., the module 11 in FIG. 3) together. The clip 61 thus both retains adjacent upper and lower modules together (e.g., the modules 11, 3.11), and prevents water intrusion through the horizontal overlap of the two modules (e.g., the modules 11, 3.11). In standard industry practice, concrete roof tile overlap is established at approximately 3 inches (7.62 centimeters) in order to reduce water leakage. The clip 61 may be removed or omitted for the upper most module (e.g., the module 11 in FIGS. 1 and 3) so that the lower edge of the associated roof tile 13 can merely rest on the upper frame member 31 as clearly shown in FIG. 3. The clip 61 can be extruded out of aluminum or the like in a length designed to extend the majority of the length of the associated module 11, 2.11, 3.11. Preferably, however, two or more shorter clips 61 are provided (see FIG. 2) to allow the clips 61 to be removed or omitted from only a portion of the length of a module in a staggered module/roof tile installation when roof tiles 13 overlie only a portion of the length of the upper frame member 31 of a module (e.g., the modules 2.11, 3.11 in FIG. 1) while an upper module (e.g., the module 11 in FIG. 1) overlie over parts of the upper frame member 31.

A bottom mounting clip 69 is shown in FIGS. 2, 3 and 8 for use in securing the lower edge of the lower row of modules (e.g., the modules 2.11, 3.11 in FIG. 2) and the upper edge of lower roof tiles 13 together. The bottom mounting clip 69 removably mounts to the associated roof tiles 13 via the screws 25 or the like. Even when used to mount the bottom mounting clips 69, the screws 25 still extend into a batten 19 but not through the roof deck 17 (see FIG. 3) so as not to compromise the waterproof integrity of the roof 15. The rearwardly extending bottom lip 67 of the lower frame member 33 of an upper module (i.e., the module 3.11 in FIG. 3) can slip under the bottom mounting clip 69 fixed to an associated roof tile 13 during installation to secure the top edge of the upper module (e.g., the module 3.11 in FIG. 3) and the upper edge of the associated roof tile 13 together as clearly shown in FIG. 3. Concrete roof tiles 13 typically have two spaced apart mounting holes or apertures 21 used to secure the roof tiles 13 to battens 19, and thus to a roof 15. Likewise, the bottom mounting clip 69 preferably has spaced apart slots 71 for being aligned with the apertures 21 in the associated roof tile 13. The slots 71 preferably extend horizontally to allow adjustment for concrete roof tiles 13 having a variety of distances between the mounting holes 25, etc. The clip 69 can be extruded out of aluminum or the like in a length designed to extend the majority of the length of the associated module 11, 2.11, 3.11. Preferably, however, two or more shorter clips 69 are provided (see FIG. 2) to allow the clips 69 to be used for only a portion of the length of a module in a staggered module/roof tile installation when roof tiles 13 overlie only a portion of the length of a module as will now be apparent to those skilled in the art.

An electrical cable restraint 73 may mounted into an unused portion of a screw bead 39 of the frame 29 of each module 11, 2.11, 3.11, etc., via a screw 75 or the like (see FIG. 9).

In the preferred embodiment of the present invention, because of the specific design of the frame 29 and associated attachment brackets and mounting clips, etc., the overlap between adjacent photovoltaic modules 11, 2.11, 3.11, etc., is allowed to be significantly smaller, thus both resisting water intrusion and allowing the use of less material and simpler design in module development and manufacture.

The present invention thus allows a photovoltaic system of interlocking rooftop modules 11, 2.11, 3.11, etc., to be installed on a sloping roof 15 with an electrical grounding lug 41 attached to, or with electrical grounding lug 45 integral with, an unused portion of a screw bead 39 of the frame 29 of each module 11, 2.11, 3.11, etc.; with a top mounting clip 61 for interlocking rows of the photovoltaic modules 11, 2.11, 3.11, etc., together while preventing water intrusion; with the modules 11, 2.11, 3.11, etc., mounted solely on roof battens 19, roof tiles 13, and other photovoltaic modules 11, 2.11, 3.11, etc.; with an upper attachment bracket 53 for attaching the upper edge of each modules 11, 2.11, 3.11, etc., to the roof 15 via slots 57 that allow adaptation to multiple sizes of concrete roof tiles 13; with a side frame water channel that allows adaptation to multiple sizes of concrete roof tiles 13; with a bottom mounting clip 69 for restraint of the front edge of modules 11, 2.11, 3.11, etc., to roof tiles 13; and with an electrical cable restraint 73 mounted into an unused portion of a screw bead 39 of the frame 29 of each module 11, 2.11, 3.11, etc.

Although the present invention has been described and illustrated with respect to preferred embodiments and preferred uses therefor, it is not to be so limited since modifications and changes can be made therein which are within the full intended scope of the invention.

1. A photovoltaic module for installation with roof tiles on a sloping roof, said photovoltaic module comprising: a photovoltaic panel; a frame surrounding said panel; and attachment means for attaching said photovoltaic module to a sloping roof in an interlocking and overlapping fashion with roof tiles while allowing adjustment of the location of said photovoltaic module along the slope of the sloping roof.

2. The photovoltaic module of claim 1 in which said frame includes a screw bead; and in which is included an electrical grounding lug attached to said screw bead.

3. The photovoltaic module of claim 1 in which said frame includes a screw bead; and in which is included an electrical grounding lug integral with said screw bead.

4. The photovoltaic module of claim 1 in which said frame includes a screw bead; and in which is included a plurality of electrical grounding lugs integral with said screw bead.

5. The photovoltaic module of claim 1 in which the sloping roof has battens to which the roof tiles are attached; and in which said attachment means allows said panel and said frame to be attached to the battens of the sloping roof.

6. The photovoltaic module of claim 5 in which said attachment means allows said panel and said frame to be attached to the battens of the sloping roof without penetrating other parts of the sloping roof.

7. The photovoltaic module of claim 1 in which said frame includes an upper frame member having a generally vertical face side; in which is included a top mounting clip for allowing an upper photovoltaic module to be clipped thereto; and in which is included an attachment member for attaching said top mounting clip to said generally vertical face side of said upper frame member.

8. The photovoltaic module of claim 1 in which said frame includes an upper frame member; and in which is included an upper attachment bracket for being attached to the sloping roof and to said upper frame member.

9. The photovoltaic module of claim 8 in which said upper attachment bracket has vent holes therein to reduce heat build-up beneath said photovoltaic module.

10. The photovoltaic module of claim 1 in which said frame includes a lower frame member; in which is included a bottom mounting clip for clipping to said lower frame member of said frame and for being attached to a roof tile.

11. The photovoltaic module of claim 1 in which is included an electrical cable restraint attached to said frame.

12. A photovoltaic system for use with concrete roof tiles on a sloping roof, said photovoltaic system comprising, in combination:
(a) a first photovoltaic module including a photovoltaic panel, a frame surrounding said panel, and attachment means for attaching said first photovoltaic module to the sloping roof while allowing adjustment of the location of said first photovoltaic module along the slope of the sloping roof;
(b) a second photovoltaic module including a photovoltaic panel, a frame surrounding said panel, and attachment means for attaching said second photovoltaic module to the sloping roof while allowing adjustment of the location of said second photovoltaic module along the slope of the sloping roof; and
(c) a third photovoltaic module including a photovoltaic panel, a frame surrounding said panel, and attachment means for attaching said third photovoltaic module to the sloping roof while allowing adjustment of the location of said third photovoltaic module along the slope of the sloping roof.

13. The photovoltaic system of claim 12 in which said frame of each of said photovoltaic modules has an upper frame member, a lower frame member, a right side frame member, and a left side frame member; in which said upper frame member of said frame of each of said photovoltaic modules is adapted to underlie the lower edge of a roof tile or said lower frame member of said frame of an adjacent photovoltaic module; in which said lower frame member of said frame of each of said photovoltaic modules is adapted to overlie the upper edge of a roof tile or said upper frame member of said frame of an adjacent photovoltaic module; in which said right side frame member of said frame of each of said photovoltaic modules is adapted to form a water tight channel with the left side edge of a roof tile or said left side frame member of said frame of an adjacent photovoltaic module; and in which said left side frame member of said frame of each of said photovoltaic modules is adapted to form a water tight channel with the right side edge of a roof tile or said right side frame member of said frame of an adjacent photovoltaic module.

14. The photovoltaic system of claim 12 in which said frame of each of said photovoltaic modules has a screw bead; and in which is included an electrical grounding lug attached to said screw bead of said photovoltaic modules.

15. The photovoltaic system of claim 12 in which said frame of each of said photovoltaic modules has a screw bead; and in which is included an electrical grounding lug integral with said screw bead of said photovoltaic modules.

16. The photovoltaic system of claim 12 in which the roof has a roof deck; and in which each of said photovoltaic modules is attached to said roof without penetrating the roof deck.
